(19) United States
(12) Patent Application Publication
(10) Pub. No.: US 2012/0042268 A1
(43) Pub. Date: Feb. 16, 2012

(54) PROCESSING USER INTERFACES

(76) Inventor: FRANK EDUGHOM EKPAR, Aizuwakamatsu City (JP)

(21) Appl. No.: 13/280,378

(22) Filed: Oct. 25, 2011

Related U.S. Application Data
(63) Continuation-in-part of application No. 11/097,879, filed on Apr. 4, 2005.
(60) Provisional application No. 60/559,939, filed on Apr. 3, 2004.

(51) Int. Cl. G06F 3/048

(52) U.S. Cl. 715/763

(57) ABSTRACT

The present invention discloses automatic and manual processing systems for a versatile graphical user interface comprising one or more N-dimensional background elements each of which is divided into one or more arbitrarily-shaped N-dimensional partitions, wherein each partition may contain one or more user interface elements and is associated with one or more sets of rules that define rendering, positioning, element placement and other relevant attributes and behaviors, wherein said rules can be specified in such a way as to enable said N-dimensional background to assume any desired arbitrary shape and to facilitate expansion to any desired arbitrary size without distortion or loss in quality.

### CROSS-REFERENCE TO RELATED APPLICATIONS

This United States (U.S.) Non-Provisional Application is a Continuation-In-Part of U.S. Non-Provisional application Ser. No. 11/097879 filed on Apr. 4, 2005 which claims the benefit of U.S. Provisional application Ser. No. 60/559,939, filed on Apr. 3, 2004, herein incorporated by reference.

### BACKGROUND OF THE INVENTION

1. Field of the Invention

The present invention relates generally to the field of graphical user interfaces. In particular, the invention relates to a graphical user interface system permitting the creation of rich multi-dimensional graphical user interfaces that can have any shape and that can dynamically be expanded to any size without distortion or loss in quality and that comprise systems for automatic processing of the user interface.

2. Description of the Prior Art

Contemporary graphical user interfaces are limited in that when they allow arbitrary shapes, they are generally not expandable and when they are expandable, they generally do not permit the use of arbitrary shapes. Furthermore, these graphical user interfaces are generally limited to flat 2-dimensional or at best simulated 3-dimensional structures. Popular graphical user interface systems from software developers such as Microsoft and Apple suffer from these limitations.

Liu et al. (US2005/0172239 A1) teach a graphical user interface that could be stretched or resized. The characteristics or nature of designated areas (such as “border” or “resize” regions) could be used to provide hints (such as a change in the shape of the cursor) to the user that resizing or stretching is possible or occurring at a particular position. However, Liu et al. fail to teach the use of adaptive or selective rendering of the areas of the graphical user interface to achieve the said resizing or stretching. In fact, Liu et al. fail to teach any specific way to achieve the resizing or stretching at all.

Furthermore, Liu et al. teach “creating one or more first regions . . . ” and “creating one or more second regions” for the user interface. Thus, Liu et al. teach the use of at least two regions—at least one first region and at least one second region.

N. M. et al. (US 2003/0041099 which has matured into U.S. Pat. No. 7,165,225) teach a graphical user interface (GUI) based on GUI objects but fail to teach any specific way of resizing the user interface.

Hamlet et al. teach the use of “optimized vector image data” to enable the display of a graphical user interface in any shape and at any size with minimal or no loss of original image quality, Hamlet et al. fail to provide the option of utilizing the nature (related to the appearance or texture) of the original image. In fact, Hamlet et al. teach away from the use of the appearance of the original image. However, according to the principles of the present invention, the adaptive or selective application of appropriate rules to selected regions of the original image based on the nature (related to the texture or appearance of same) can achieve “infinite resolution” and permit the user interface to assume any desired shape and size without easily noticeable distortion or loss of quality. Additionally, it should be noted that according to the teachings of Hamlet et al., the “optimized vector image data” is generally created separately and could also be stored separately from the graphical user interface to which it is applied and that changes in certain attributes (such as size) of the interface may necessitate re-computation of vector data. In contrast, the present invention provides the option of directly using the original image and adaptively applying appropriate rules to selected regions of the image with suitable characteristics to facilitate user interfaces that can assume any size and shape. Thus, the options provided by the present invention obviate the need to generate, access or otherwise compute or re-compute vector data, leading to savings in resources and allowing for faster and more responsive and richer user interfaces than permitted by the prior art.

Callaghan et al. (US2005/0108364 A1) teach a graphical user interface that employs scalable vector graphics (SVG) for rendering—including scaling, resizing or stretching. Similarly, Kaasila et al. (U.S. Pat. No. 7,222,306 B2) teach a graphical user interface that utilizes a plurality of scale factors for scaling, resizing or stretching. It should be noted that although the scale factors utilized by Kaasila et al. can be selected from a list of available scale factors or generated in response to user interaction with the user interface.

None of the prior art (N. M: US2003/0041099, Hamlet et al.: U.S. Pat. No. 6,606,103, Liu et al.: US2005/0172239 A1, Callaghan et al.: US2005/0108364 A1, Kaasila et al.: U.S. Pat. No. 7,222,306 B2) teaches a user interface wherein resizing is based on the nature of selected regions.

Similarly, none of the prior art (N. M: US2003/0041099, Hamlet et al.: U.S. Pat. No. 6,606,103,Liu et al.: US2005/0172239 A1, Callaghan et al.: US2005/0108364 A1, Kaasila et al.: U.S. Pat. No. 7,222,306 B2) teaches a user interface wherein one or more design characteristics of one or more partitions are guided by one or more intended presentation characteristics of the affected partition.

### SUMMARY OF THE INVENTION

It is an object of the present invention to overcome the limitations of the prior art set forth above by providing a versatile graphical user interface comprising one or more N-dimensional background elements each of which is divided into one or more arbitrarily-shaped N-dimensional partitions, wherein each partition is associated with one or more sets of rendering, positioning, element placement and other relevant rules and may contain one or more user interface elements—thus enabling said N-dimensional background to assume any desired arbitrary shape and to facilitate expansion to any desired arbitrary size without distortion or loss in quality. This leads to much more versatile, more dynamic and richer user interfaces than are possible with the prior art.

The present invention also discloses a system for the automatic or manual processing of the user interface to facilitate dynamic resizing of the interface.

### BRIEF DESCRIPTION OF THE DRAWINGS

FIG. 1 illustrates partitioning for a preferred embodiment of the present invention.

FIG. 2 shows a flowchart for the processing of the user interface for a preferred embodiment of the present invention.

### DETAILED DESCRIPTION OF THE PREFERRED EMBODIMENTS

Generally, a computer system such as a personal computer system, workstation, server, tablet computer system, handheld or mobile computer system and any other suitable system could be used to embody the present invention. Other suitable devices and systems providing means for or allowing the steps of the present invention to be carried out could be used. When a computer system is used, user interaction with the user interface could be via a mouse or any other suitable means. Data for the interface could be stored in computer memory and software running on the computer system could be used to allow editing and presentation of the user interface. The user interface could be presented or rendered on a computer monitor or screen. Suitable computer network systems could be used to implement and/or present aspects of the user interface.

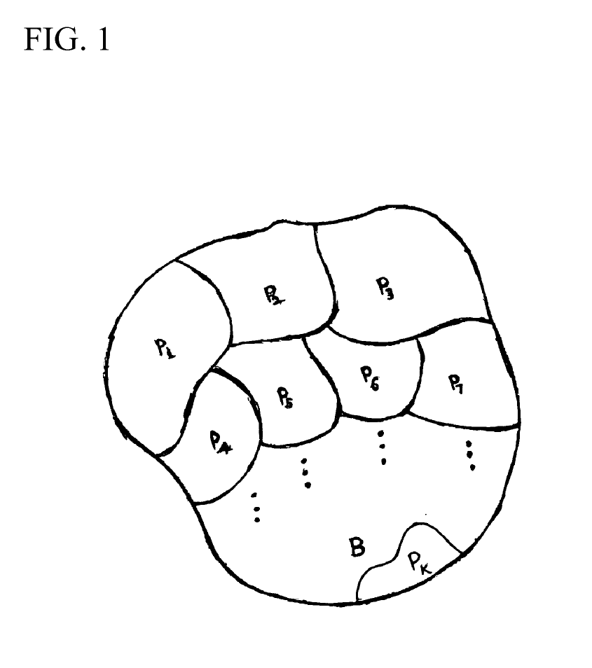

Referring now to FIG. 1, an illustration of a preferred embodiment of the present invention, the arbitrarily-sized and arbitrarily-shaped background is indicated generally as B. In FIG. 1, P.sub. 1, P.sub. 2, P.sub. 3, P.sub. 4, P.sub. 5, P.sub. 6, P.sub. 7, . . . , P.sub. K are partitions. K can be any number. For simplicity, the background and partitions in FIG. 1 are 2-dimensional. Furthermore, the partitions are contiguous. In practice, however, the background and partitions are N-dimensional (where N can be 1, 2, 3, 4—for 3 spatial dimensions and 1 temporal dimension for instance, 5, or any number of dimensions) and the partitions need not be contiguous. Furthermore, the partitions need not be literal—in which case a background comprising a two-dimensional image would need to be broken up into a plurality of images to support a plurality of partitions—but could be logical or conceptual only—in which case said background image could remain monolithic. Each partition may contain any number of user interface elements. According to the principles of the present invention, each partition has an arbitrary shape and an arbitrary size and is associated with a set of rules that define rendering, positioning, element placement and other relevant behaviors and attributes. (Generally, attributes and behaviors or characteristics or aspects of the user interface are chosen on the basis of usefulness or relevance in a given embodiment.) These rules can be specified in such a way that the N-dimensional background-based graphical user interface can assume any arbitrary desired shape and can be expanded to any arbitrary desired size without distortion or loss in quality. For instance, if the background comprises a single, arbitrarily-shaped digital image and the user interface built from said background is to be rendered on a computer screen, then said background can be divided into a number of partitions based on the nature of the background and the rendering of each partition can in turn be carried out on the basis of the nature of the partition. A partition defined on a uniformly textured region of the background can be stretched without noticeable distortion or loss in quality. In contrast, a partition defined on a non-uniform region of the background may be rendered in its original size and shape to prevent distortion and loss in quality. By creating a number of partitions based on the nature of the background and selectively assigning appropriate sets of rules for rendering, positioning, component placement and other behaviors and attributes of each partition, the entire background can be made to assume an arbitrary shape and an arbitrary size without distortion or loss in quality. Consequently, user interfaces based on the principles of the present invention are more versatile, more dynamic and allow a much richer user experience than is possible with the prior art.

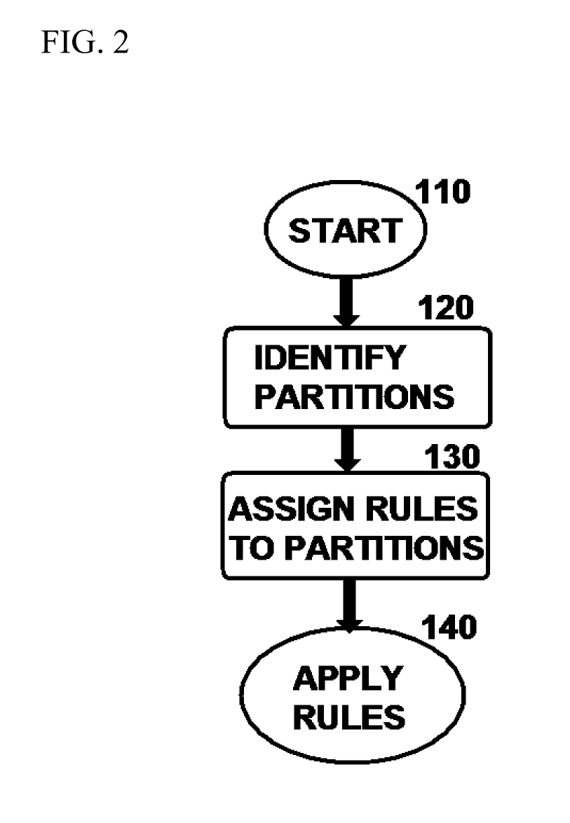

FIG. 2 shows a flowchart for automatic processing of the user interface. The user interface could comprise a background image that is to be partitioned. Partitioning could be based on the nature of the image. For example, the texture of the image could be used.

In the step indicated generally as 110 (START) in FIG. 2, the image could be prepared for processing. Such preparation could involve storing the image in memory and providing means of accessing the data representing the image. It could also comprise—in the case of a network-based system—the streaming or transmission of the data representing the image for further manipulation. If required, preparation could also involve pre-processing steps such as filtering and de-noising of the image or the application of any combination of any required pre-processing steps as is well-known in the art.

In the step labeled 120 (IDENTIFY PARTITIONS), an automatic process for the identification of distinct partitions or regions within the image could be carried out. The identification could be based on the texture of the image. Image segmentation techniques (including those popular in the literature) could be used in this step. Any other suitable process for automatically identifying partitions could also be used. The process could be completely automated—in which case the results of an automatic image processing step such as image segmentation are used as the basis for partitioning the image. Furthermore, a semi-automatic process could be used—in which case the automatic partition identification process could be augmented (via user or designer inspection) to manually correct any misidentifications or to more closely conform to user taste. More generally, the step of identifying partitions in the user interface comprises assigning a label to each element in the image such that elements with the same label share common characteristics. In the case of a digital image, each such element would be a pixel. For simplicity, the texture of the image could be chosen as the characteristic on which the labeling of elements is based. It should be noted that any other suitable characteristic (including, but not limited to, shape) could be chosen as the basis of the partitioning. Typical labels could be SIMPLE (for elements with a simple or uniform texture), COMPLEX (for elements with a relatively more complex texture), HORIZONTAL (for elements with a texture that appears horizontal) and VERTICAL (for elements with a texture that might appear vertical). Other suitable labels could be used. For simplicity, the boundaries of identified partitions could be expanded to abut neighboring partitions when necessary in order to ensure that all identified partitions taken together cover the entire background without gaps.

According to the principles of the present invention, the partitioning process is not limited to the automatic and/or semi-automatic processes described in the foregoing. Partitioning could be carried out manually on the basis of a visual inspection of the user interface. Manual identification of partitions could be accomplished on a computer system via suitable instructions (possibly embodied in application software) that permit the designer or user to identify and/or label partitions. This could be accomplished by clicking and dragging a computer mouse over the background image to demarcate or identify and/or label partitions. The labels (for example SIMPLE, COMPLEX, HORIZONTAL, VERTICAL, etc) mentioned for automatic and/or semi-automatic partition identification could also be applied to manual partition identification.

In step 130 (ASSIGN RULES TO PARTITIONS), each partition identified in step 120 could be associated with a set of rules defining the characteristics of the partition. For example, based on the texture of the identified partition, a specific partition could be designated for vertical tiling during rendering or presentation. By way of example, consider the situation in which the rendering or presentation of the user interface is the characteristic that is to be defined. Any partition labeled SIMPLE could be assigned a rendering or presentation rule that effectively causes the partition to be stretched to fit its destination. In the case of a two-dimensional digital image, this could be accomplished via simple two-dimensional (horizontal and vertical) pixel replication as is well known in the field. In contrast, a partition labeled COMPLEX could be assigned a rendering or presentation rule that effectively causes the partition to be rendered at its actual size—in which case any destination region allocated to the partition could be constrained to the same size and shape as the original partition. A partition labeled HORIZONTAL could be assigned a rendering or presentation rule that effectively causes the partition to be tiled horizontally while a partition labeled VERTICAL could be assigned a rendering or presentation rule that effectively causes be partition to be tiled vertically during rendering or presentation on a destination surface or device.

One of ordinary skill in the art would appreciate that it is possible to synthesize a mapping or table associating rules or sets of rules for rendering (or any other chosen characteristic) with a label or sets of labels identifying partitions within the interface.

Finally, assigned rules can be applied in step 140 to the associated partitions in the storage, presentation and/or more generally further manipulation of the user interface.

Additionally, identification of partitions and/or assignment of rules to identified partitions could also be based on a selected user or designer profile. Such a profile could be built up automatically on the basis of prior user interaction with the user interface, user preferences or other relevant data gathered about the user or designer. For example, a specific user or designer could prefer that SIMPLE partitions be tiled vertically while another could prefer that such partitions be simply stretched via pixel replication or an equivalent process. Via appropriate program code or computer software, the user or designer could be permitted to edit such a profile or build a new profile from scratch. Thus, user or designer profiles could be built explicitly on the basis of user or designer input. Another option is to use a semi-automatic approach in which a user or designer profile could first be built automatically (possibly on the basis of the known behavior and/or preferences of a wide spectrum of users or designers or via some other suitable means) and the automatically synthesized profile subjected to optional editing by users or designers.

The background, partitions, associated user interface elements, user or designer profiles and any required configuration information could be managed as elements in a universal file format. Such a universal file format would specify a header identifying the file type and containing information as to the number, types, locations and sizes of the elements it contains. Each element in the file is in turn described by a header specifying the type of the element, its size and any relevant data or attributes and the types, locations and sizes of any additional elements it contains. By making use of self-describing elements in the manner explained in the foregoing, the universal file format would be able to store an arbitrary element having an arbitrary number and types of other such elements embedded in it.

It should be understood that numerous alternative embodiments and equivalents of the invention described herein may be employed in practicing the invention. Thus, it is intended that the appended claims define the scope of the invention and that methods and structures within the scope of these claims and their equivalents be covered thereby.

What is claimed is:

1. A method for creating a graphical user interface comprising steps of:
dividing one or more arbitrarily-sized and arbitrarily-shaped N-dimensional background elements into one or more arbitrarily-sized and arbitrarily-shaped N-dimensional partitions, wherein each partition may contain user interface elements and is associated with one or more sets of rules that define attributes and/or behaviors of said graphical user interface, wherein said rules can be based on the nature of selected regions and can be specified in such a way that said background can assume any desired arbitrary shape and can be expanded to any desired arbitrary size without easily noticeable distortion or loss in quality;
displaying representations of said graphical user interface and/or permitting interaction with said graphical user interface.

2. The method of claim 1 wherein said partitions are identified manually.

3. The method of claim 1 wherein said partitions are identified automatically.

4. The method of claim 1 wherein said partitions are identified semi-automatically.

5. The method of claim 1 wherein said partitions are identified on the basis of a user or designer profile.

6. The method of claim 5 wherein said user or designer profile is synthesized manually.

7. The method of claim 5 wherein said user or designer profile is synthesized automatically.

8. The method of claim 5 wherein said user or designer profile is synthesized semi-automatically.

9. The method of claim 5 wherein said user or designer profile is managed using a universal file format.

10. A method for creating a graphical user interface comprising steps of:
dividing one or more arbitrarily-sized and arbitrarily-shaped N-dimensional background elements into one or more arbitrarily-sized and arbitrarily-shaped N-dimensional partitions, wherein resizing is based on the nature of selected regions;
displaying representations of said graphical user interface and/or permitting interaction with said graphical user interface.

11. The method of claim 10 wherein said partitions are identified manually.

12. The method of claim 10 wherein said partitions are identified automatically.

13. The method of claim 10 wherein said partitions are identified semi-automatically.

14. The method of claim 10 wherein said partitions are identified on the basis of a user or designer profile.

15. The method of claim 14 wherein said user or designer profile is synthesized manually.

16. The method of claim 14 wherein said user or designer profile is synthesized automatically.

17. The method of claim 14 wherein said user or designer profile is synthesized semi-automatically.

18. The method of claim 14 wherein said user or designer profile is managed using a universal file format.

19. A method for creating a graphical user interface comprising steps of:
dividing one or more arbitrarily-sized and arbitrarily-shaped N-dimensional background elements into one or more arbitrarily-sized and arbitrarily-shaped N-dimensional partitions, wherein one or more design characteristics of one or more partitions are guided by one or more intended presentation characteristics of the affected partition;
displaying representations of said graphical user interface and/or permitting interaction with said graphical user interface.

20. The method of claim 19 wherein said partitions are identified manually.

21. The method of claim 19 wherein said partitions are identified automatically.

22. The method of claim 19 wherein said partitions are identified semi-automatically.

23. The method of claim 19 wherein said partitions are identified on the basis of a user or designer profile.

24. The method of claim 23 wherein said user or designer profile is synthesized manually.

25. The method of claim 23 wherein said user or designer profile is synthesized automatically.

26. The method of claim 23 wherein said user or designer profile is synthesized semi-automatically.

27. The method of claim 23 wherein said user or designer profile is managed using a universal file format.
